(19) United States
(12) Patent Application Publication
(10) Pub. No.: US 2013/0289940 A1
(43) Pub. Date: Oct. 31, 2013

(54) DEVICE FOR MONITORING THE FUNCTIONALITY OF A VALVE

(71) Applicants: Felix Ams, Kaempfelbach (DE); Reiner Ritter, Maulbronn (DE)

(72) Inventors: Felix Ams, Kaempfelbach (DE); Reiner Ritter, Maulbronn (DE)

(21) Appl. No.: 13/568,634

(22) Filed: Aug. 7, 2012

(30) Foreign Application Priority Data
Apr. 26, 2012 (EP) 12 002 902.0

(51) Int. Cl. G06F 15/00

(52) U.S. Cl. 702/183

(57) ABSTRACT

A device for monitoring the functionality of a valve includes the valve, a digital diagnostic module and a programming device. The valve has a sensor actuator connected to a valve element for combined reciprocating motion, a distance sensor that interacts with the sensor actuator to generate analog distance values characterizing lift positions of the valve element. The diagnostic module diagnoses switching states of the valve element based on the distance values and, includes an analog input connected to the distance sensor, a downstream A/D converter and a serial communication connected to a digital input/output. The serial communication enables threshold values for the digital distance values that define changes to the switching state to be programmed by the programming device and transmission of diagnosed switching states.

### CROSS-REFERENCE TO A RELATED APPLICATION

The invention described and claimed hereinbelow is also described in European Patent Application EP 12 002 902.0, filed on Apr. 26, 2012. This European Patent Application, whose subject matter is incorporated here by reference, also provides the basis for a claim of priority of invention under 35 U.S.C. 119(a)-(d).

### BACKGROUND OF THE INVENTION

The invention relates to a device for monitoring the functionality of a valve, which valve comprises a valve housing having a valve opening and a valve element that can be driven to move in a reciprocating manner for closing and opening the valve opening. The device for monitoring the functionality of the valve comprises a sensor actuator, which is connected to the valve element for combined reciprocating motion, and a distance sensor, which is disposed at the valve housing, interacts with the sensor actuator and generates analog distance values that characterize lift positions of the valve element.

A known device for monitoring the valve lift of an electromagnetically driven valve that comprises a coil, a yoke housing, an armature and a return spring has, as the sensor actuator, an annular magnet mounted on the armature. The known device also has, as the distance sensor, a Hall sensor switch disposed opposite thereto in the yoke housing. The Hall sensor switch is connected on an output side to an external evaluation circuit and to a supply voltage Ue of the coil. If the coil is not electrically energized, i.e. Ue is 0 volts. With Ue at 0 volts, the armature is located in the neutral position thereof, and the Hall sensor switch is exposed to the magnetic field of the magnet. As the output voltage Ua is 0 volts at the outlet of the Hall sensor switch, both Ua and Ue are 0 volts at the evaluation circuit. This characterizes the switching state of the evaluation circuit as “electrically de-energized.”

If the supply voltage Ua of 10 volts is, for example, applied to the coil, the armature is drawn against the reset spring by a distance z, which depends on the physical design. The magnet is drawn away from the Hall sensor switch by the same distance and, therefore, the magnetic field is withdrawn from the latter or is diminished. The Hall sensor switch closes the contact thereof and connects the supply voltage, Ue=10V, to the output. The output voltage at the evaluation circuit is, therefore, Ua=10V. By way of a comparison of Ue and Ua in the evaluation circuit, the travel z that took place is determined and the switching state is characterized as “electrically energized.” The function of the switching valve is actuated by both values of the switching state.

### SUMMARY OF THE INVENTION

The present invention provides a device for monitoring the functionality of a valve that overcomes the shortcomings of known arts, such as those mentioned above.

The inventive device for monitoring the functionality of a valve can be used universally with a variety of valves, independently of the valve type and the production tolerances of the valve.

The inventive valve monitoring device al can be used for the superimposed control of the valve.

The valve monitoring device according to the invention has the advantage that it is extremely flexible and can be matched to the individual valve by way of simple programming, wherein tolerances of the mechanical and electrical parts of the valve are equalized in a fully automatic manner. The programming is performed easily without intervening in the valve or the monitoring device by utilizing a programming device such as a PC.

By selecting the threshold values accordingly, switching points of the valve element are set such that two or more switching states are reliably detected. By suitably setting the threshold values with respect to magnitude and hysteresis, the travel end values of the valve element are monitored during operation and the diagnostic module is able to detect wear of the valve, e.g., wear of the seal contour of an elastic seat seal at the valve opening, by way of changes in the travel end values.

The diagnosis of the switching states transferred from the serial communication to the digital input/output is used as the basic information for the superimposed control of the valve. Moreover, the programming of the diagnostic module via the serial communication makes it possible to digitally compensate for the temperature dependence of the distance sensor and to linearize the travel characteristic curve. That is, the programming compensates for the distance influences of the distance sensor, thereby making it possible to use the digital distance values transferred via the serial communication to the digital input/output as distance-proportional measured values for the superimposed control of proportional valves.

In an embodiment, the invention provides a diagnostic module comprising a parameter memory that is readable/writable via the serial communication by way of the programming device, which can be connected at the digital input/output, in which the threshold values are stored, and preferably comprises a comparator that can be provided on the input side with the digital distance values and with the threshold values, and, on the output side, is connected to the digital on/off switch by way of a switching output. The comparator compares the digital distance values with the threshold values and transfers binary information that characterizes the switching state of the valve element to the switching output. The binary information at the switch outlet is available at the digital inlet/outlet as the basic information “valve is switched” or “valve is not switched” for a superimposed control of the valve. The binary information also is used in the diagnostic module to generate various statements regarding the vitality of the valve such as age, wear, bounce of the valve element at the end stops, etc.

I an embodiment, the diagnostic module comprises a digital evaluation unit, which correlates the digital distance values to the binary information at the switching output and, on the basis thereof, generates an evaluation of the functionality of the valve element. The evaluation is transmitted via the serial communication. For the evaluation, a maximum number of operating cycles for the valve element is stored in the parameter memory by way of the serial communication. The evaluation unit counts, on the basis of the correlation of the digital distance values and the threshold values, the number of operating cycles, that is, the number of changes of the switching states of the valve element. If the maximum operating cycle number is exceeded, the evaluation unit generates the functionality evaluation “ageing” as an alarm message or a displayed value.

In an embodiment, a maximum frequency for the operating cycles of the valve element also is stored in the parameter memory by way of the serial communication. The evaluation unit counts, on the basis of the correlation of the digital distance values and the threshold values, the operating cycles per unit of time. If the stored maximum frequency is exceeded, the evaluation unit generates a functionality assessment “bouncing” as an alarm message or displayed value. Providing such indication that the valve is defective makes it possible to repair or replace the defective valve.

In an embodiment, the digital distance values fed to the comparator, the digital evaluation unit and the serial communication are derived from the analog distance values. The analog distance values are converted by the analog/digital converter, by way of temperature compensation, filtering, amplification, zero offset and linearization. Therefore, all environmental influences on the correct measurement of the distance values of the distance sensor are eliminated. Relevant temperature coefficients for temperature compensation, limit frequencies for filtering, amplification coefficients for amplification, offset for the zero offset and compensation functions for linearization are read into the parameter memory via the serial communication.

### BRIEF DESCRIPTION OF THE DRAWINGS

Further features and advantages of the invention will become apparent from the description of embodiments that follows, with reference to the attached figures, wherein:

FIG. 1 a schematic depiction of a partially exposed valve and a device for monitoring the functionality of the valve; and

FIG. 2 a block diagram of a digital diagnostic module in the monitoring device according to FIG. 1.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

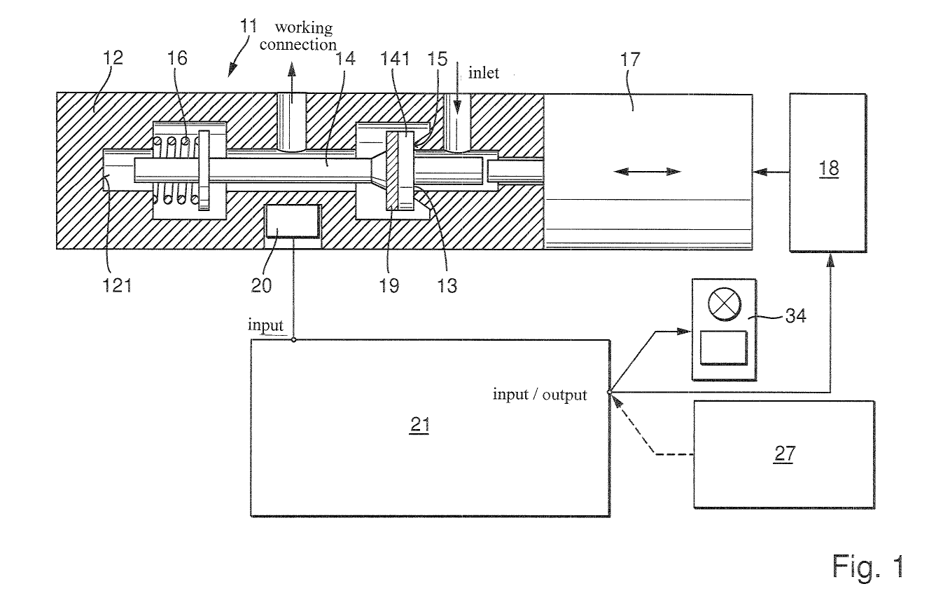

Valve 11 is illustrated schematically in FIG. 1 in a partial longitudinal cross-sectional view, in the form of a switching valve or a 2/2-directional control valve that has two switching states in which a passage for a fluid (gas or fluid) from an inlet P to a working connection A is blocked or released. Valve 11 also has a plurality of switching states, such as a 3/3- or 4/3-directional control valve, or may be designed as a proportional valve.

Valve 11 comprises a valve housing 12 having a valve opening 13 and a valve element 14 that is driven to move in a reciprocating manner for closing and opening the valve opening 13. The valve opening 13 is disposed between an inlet P and a working connection A and is enclosed by a valve seat 15. The valve element 14 having a closing head 141 is pressed onto the valve seat 15 by way of a reset device 16 and closes the valve opening 13. The reset device 16 is a compression spring in the embodiment shown, but also can be implemented in the form of a pressure differential, a permanent magnet or a second actuator.

The closing element 141 is lifted off of the valve seat 15 against the closing force of the reset device 16 by way of an actuator 17 acting on the valve element 14, thereby opening the valve opening 13. The reciprocating motion of the valve element 14 is limited by an end stop 121 formed in the valve housing 12. In the embodiment shown, the actuator 17 is an electromagnet, to which a control voltage or a control current is applied in a defined manner via a controller 18. The actuator 17 is any of a piezoelectric or magnetoresistive actuator, an electric motor or a hydraulic actuator, without limitation.

The functionality of the valve 11 is monitored by a device that comprises a sensor actuator 19 and a distance sensor 20 and a digital diagnostic module 21. The sensor actuator 19 is connected to the valve element 14 for combined reciprocating motion. The distance sensor 20 is disposed at the valve housing 12, interacts with the sensor actuator 19 and generates the analog distance values that characterize the lift positions of the valve element 14 and can be tapped at the output of the distance sensor 20. In the embodiment, the sensor actuator 19 is a magnet and the distance sensor 20 is a Hall sensor. It also is possible to use ultrasonic sensors, optical, inductive or capacitive distance sensors, and mechanically actuated potentiometers as the distance sensors.

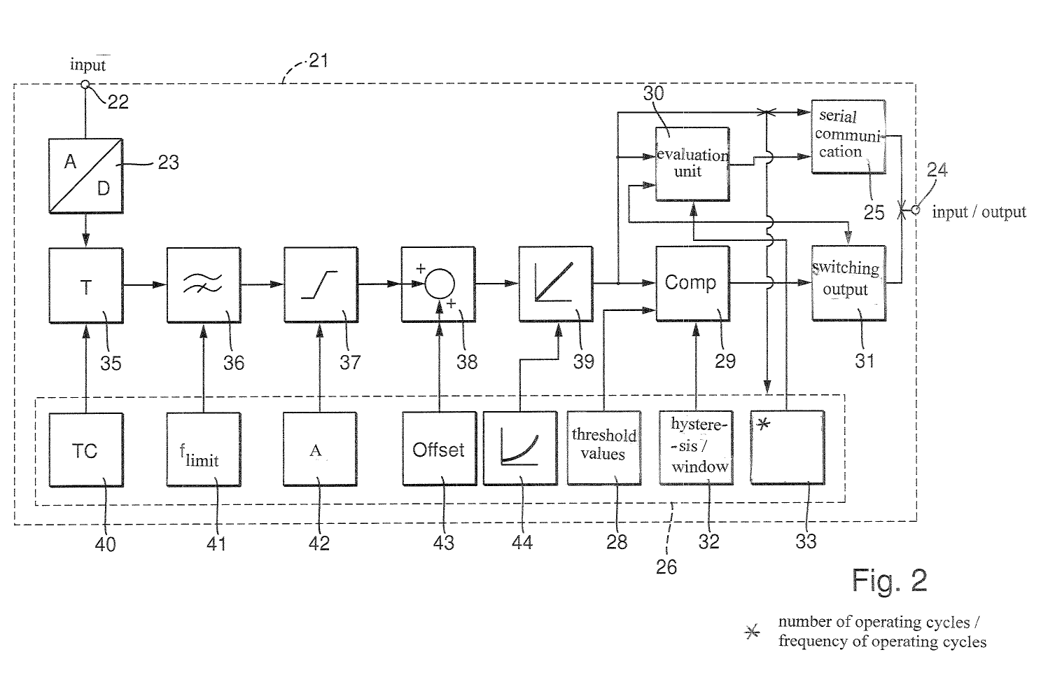

The digital diagnostic module 21, as shown in FIG. 2, comprises an analog input 22 and serial communication 25. The analog input 22 is connected to the output of the distance sensor 20 and has a downstream analog-digital (ND) converter 23. The serial communication 25 is connected to a digital input/output 24. The analog distance values of the distance sensor 20 that reach the analog input 22 are available, after analog-digital conversion and passing through a plurality of functional elements, as digital distance values in the diagnostic module 21. The serial communication 25 allows for transmission of switching states that are diagnosed in the digital diagnostic module 21 on the basis of the digital distance values and for programming threshold values for the digital distance values that define changes of the switching state of the valve element 14.

To this end, the diagnostic module 21 comprises a parameter memory 26, which can be written to or read from via the serial communication 25 by way of a programming device 27 that is connected at the digital input/output 24. The threshold values set at the factory by way of the programming device 27 are stored in said parameter memory in the memory location 28. The threshold values are calculated on the basis of the distance values that characterize the travel end values of the valve element 14, including additional safety margins.

The digital diagnostic module 21 comprises a comparator 29 and a digital evaluation unit 30 for diagnosing the switching states of the valve element 14 on the basis of the digital distance values by reference to the threshold values stored in the parameter memory 26. The comparator 29 is provided on the input side with the digital distance values and with the threshold values and, on the output side, is connected to the digital input/output 24 by way of a switching output 31. The comparator 29 compares the digital distance values with the threshold values and delivers binary information to the switching output 31 that characterizes the switching state of the valve element 14.

Default values for hysteresis or window width of the comparator 29 are stored in the memory location 32 of the parameter memory 26, which have been read in via the serial communication 25 by way of the programming device 27. In every comparison of a threshold value and a digital distance value in the comparator 29, these default values are applied to the comparator 29 and are incorporated in the detection of threshold values being exceeded or fallen below in the comparator 29. The binary information applied to the input/output 24 by way of the switching output 31 and, the digital distance values transmitted directly to the digital input/output 24 via the serial communication 25, are fed to the controller 18 (FIG. 1). The information and values are used for the superimposed control of the valve 11. As a result, a closed control loop can also be created and the flow or outlet pressure of a proportional valve can be regulated.

The digital evaluation unit 30 correlates the digital distance values to the binary information at the switching output 31. Based thereon, the digital evaluation unit 30 generates an evaluation of the functionality of the valve element 14 and transmits same via the serial communication 25 to the digital input/output 24. To this end, default values for a maximum number of operating cycles and a maximum frequency for the operating cycles are stored at the memory location 33 of the parameter memory 26. The stored default values are first read into the parameter memory 26 via the serial communication 25 by way of the programming device 27. An operating cycle is defined as the change in the switching states of the valve element 14.

On the basis of the correlation of the digital distance values and the threshold values, the digital evaluation unit 30 counts the operating cycles. If the maximum number of operating cycles that is stored is exceeded, the digital evaluation unit 30 generates a functionality evaluation “ageing” as an alarm message or a displayed value. In addition, the digital evaluation unit 30 also counts the operating cycles per unit of time and. if the maximum frequency for the operating cycles that is stored is exceeded, the digital evaluation unit 30 generates a functionality evaluation “bouncing” as an alarm message or displayed value. The alarm messages or displayed values are transmitted via the serial communication 25 to a warning device 34 (FIG. 1) connected to the digital input/output 24, where it is made visible and/or audible.

As discussed above, the digital distance values converted from analog distance values of the distance sensor 20 by the ND converter 23, present at the comparator 29 and at the digital evaluation unit 30 and transferred directly via the serial communication 25 to the input/output 24 are derived by processing in various functional elements 35, 36, 37, 38 and 39. The distance values are compensated for in the temperature element 35 with respect to the temperature dependence thereof, are filtered in the filter element 36, are amplified in the amplification element 37, are corrected with respect to the zero point thereof in the balancing element 38 and are linearized in the linearization element 39. The coefficients and functions required therefor are stored in the parameter memory 26. The individual temperature coefficients are stored in the memory location 40. The limit frequencies for filtering are stored in the memory location 41. The amplification coefficients for amplification are stored in the memory location 42. The offset for the zero offset is stored in the memory location 43 and the compensation functions for linearization are stored in the memory location 44. These memory locations also are occupied via the serial communication 25 by way of the programming device 27,

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A device for monitoring the functionality of a valve (11) comprises the valve (11), a digital diagnostic module (21) and a programming device (27);
wherein the valve (11) comprises a valve housing (12) having a valve opening (13) and a valve element (14) driven to move in a reciprocating manner for closing and opening the valve opening (13), a sensor actuator (19) that is connected to the valve element (14) for combined reciprocating motion and a distance sensor (20) that is disposed at the valve housing (12) interacts with the sensor actuator (19) and generates analog distance values that characterize lift positions of the valve element (14);
wherein the digital diagnostic module (21) diagnoses switching states of the valve element (14) on the basis of the distance values and comprises an analog input (22) connected to the distance sensor (20), a downstream A/D converter (23) and serial communication (25) connected to a digital input/output (24);
wherein the programming device (27) is connectable to the serial communication (25) through the digital input/output (24); and
wherein the serial communication (25), when the programming device (27) is connected through the digital input/output (24), enables the programming device (27) to program threshold values for the digital distance values that define changes to the switching state and enables the diagnosed switching states to be transmitted.

2. The device according to claim 1, wherein the diagnostic module (21) further comprises a parameter memory (26) in which the threshold values are stored and which can be written to and read from via the serial communication (25) by the programming device (27) when the programming device (27) is connected at the digital input/output (24).

3. The device according to claim 1, wherein the diagnostic module (21) further comprises a comparator (29) provided on an input side with the digital distance values and with the threshold values and on an output side is connected to the digital input/output (24) by way of a switching output (31) and wherein the comparator (29) compares the digital distance values with the threshold values and transfers binary information to the switching output (31), which binary information characterizes the switching state of the valve element (14).

4. The device according to claim 3, wherein default values for hysteresis or window width of the comparator (29) are stored in the parameter memory (26) can be applied to the comparator (29).

5. The device according to claim 3, wherein the diagnostic module (21) further comprises a digital evaluation unit (30), which correlates the digital distance values to the binary information at the switching output (31) and, on the basis thereof, generates an evaluation of the functionality of the valve element (14) and transmits the evaluation to the input/output (24) via the serial communication (25).

6. The device according to claim 5, wherein a maximum number of operating cycles of the valve element (14) is stored in a parameter memory (26), and the evaluation unit (30) counts the operating cycles on the basis of the correlation of the digital distance values and the threshold values and, if the stored maximum number of operating cycles is exceeded, generates the function evaluation “ageing” as an alarm message or a displayed value.

7. The device according to claim 5, where a maximum frequency for the operating cycles of the valve element (14) is stored in a parameter memory (26), the evaluation unit (30) counts the operating cycles per unit of time on the basis of the correlation of the digital distance values and the threshold values and, if the maximum frequency is exceeded, generates a functionality evaluation “bouncing” as an alarm message or displayed value.

8. The device according to claim 2, wherein the digital distance values are derived from the analog distance value converted by the A/D converter (23) by any of temperature compensation, filtering, amplification, zero offset and linearization.

9. The device according to claim 8, wherein temperature coefficients for the temperature compensation, limit frequencies for the filtering, amplification coefficients for the amplification, offset for the zero offset and compensation functions for the linearization are stored in the parameter memory (26).

10. The device according to claim 1, wherein the digital distance values are applied directly to the digital input/output (24) via the serial communication (25).
